(19) United States
(12) Patent Application Publication
(10) Pub. No.: US 2025/0062448 A1
(43) Pub. Date: Feb. 20, 2025

(54) RECHARGEABLE BATTERY AND BATTERY MODULE WITH THE SAME

(71) Applicant: SAMSUNG SDI CO., LTD., Yongin-si (KR)

(72) Inventor: Heonhee KIM, Yongin-si (KR)

(21) Appl. No.: 18/664,423

(22) Filed: May 15, 2024

(30) Foreign Application Priority Data
Aug. 17, 2023 (KR) 10-2023-0107761

(51) Int. Cl. H01M 50/103; H01M 10/0585; H01M 10/0587; H01M 10/613; H01M 10/647; H01M 10/6554; H01M 50/15; H01M 50/209; H01M 50/533; H01M 50/54

(52) U.S. Cl. CPC H01M 50/103; H01M 10/0585; H01M 10/0587; H01M 10/613; H01M 10/647; H01M 10/6554; H01M 50/15; H01M 50/209; H01M 50/533; H01M 50/54

(57) ABSTRACT

A rechargeable battery includes a can including a top portion and a side portion connected to an edge of the top portion, the top portion having a square shape, and the side portion having four surfaces, an electrode assembly inside the can, the electrode assembly including electrodes stacked between two facing surfaces of the four surfaces of the side portion, and a cap plate coupled to an end portion of the side portion, the cap plate being configured to seal the can.

### CROSS-REFERENCE TO RELATED APPLICATION

This application claims priority to and the benefit of Korean Patent Application No. 10-2023-0107761, filed at the Korean Intellectual Property Office on Aug. 17, 2023, the entire contents of which are incorporated herein by reference.

### BACKGROUND

### 1. Field

The present disclosure relates to a rechargeable battery, and more particularly, to a square pillar-type rechargeable battery.

### 2. Description of the Related Art

A rechargeable battery may be used as a power source for a small electronic device such as a mobile phone and a laptop computer, and as a power source for driving a motor in a transportation vehicle such as an electric vehicle or a hybrid vehicle. In the latter case, a battery module combining a plurality of rechargeable batteries may be used, e.g., a plurality of cylindrical rechargeable batteries.

### SUMMARY

Aspects of embodiments provide a rechargeable battery, including a can that has a top portion with a square shape and a side portion connected to an edge of the top portion and having four surfaces; an electrode assembly that is accommodated inside the can and includes a plurality of electrodes stacked along a direction in which any two of the four surfaces constituting the side portion face each other; and a cap plate that is coupled to an end portion of the side portion to seal the can.

Each of the electrodes may have a rectangular sheet shape, the electrodes being positioned in parallel to the two facing surfaces.

The electrode assembly may include tabs at each of a first side and a second side of the electrode assembly, the first side facing the top portion, and the second side facing the cap plate.

Each of the tabs may include cutting lines, each of the tabs being bent and having an overlapping portion with an adjacent one of the tabs.

Ones of the cutting lines in at least one of the tabs may be offset relative to ones of the cutting lines in an adjacent one of the tabs.

Each of the tabs may have a shape in which a protruding length of a central portion is greater than protruding lengths of both end portions.

Each of the tabs may have shape in which protruding lengths of both end portions are greater than a protruding length of a central portion.

The tabs may include a first region bent along a first direction and a second region bent along a reverse direction to the first direction.

Each of a width of the first region along the first direction and a width of the second region along the reverse direction to the first direction may be half of a width of the electrode assembly.

Ones of the cutting lines at the first region may deviate from ones of the cutting lines at the second region.

The rechargeable battery may further include at least one current collecting plate fixed to the tabs, the at least one current collecting plate being divided into a pair of plate spring portions and an edge portion surrounding the pair of plate spring portions by two through lines.

The tabs may include first tabs at the first side of the electrode assembly and facing the top portion, the first tabs being fixed to the at least one current collecting plate, and second tabs at the second side of the electrode assembly and facing the cap plate, the second tabs being fixed to the cap plate.

Aspects of embodiments provide a rechargeable battery, including a can including a top portion and a side portion connected to an edge of the top portion, the top portion having a square shape, and the side portion having four surfaces, an electrode assembly inside the can and including a sheet laminate in a square shape wound around a mandrel having a square rod shape, the sheet laminate including a first electrode sheet, a second electrode sheet, and at least one separator sheet, and the first electrode sheet including a first tab extending toward the top portion, and a cap plate coupled to an end portion of the side portion, the cap plate being configured to seal the can, and the second electrode sheet of the electrode assembly including a second tab extending toward the cap plate.

The at least one separator sheet may include a first separator sheet and a second separator sheet, and the sheet laminate may be stacked in an order of the first electrode sheet, the first separator sheet, the second electrode sheet, and the second separator sheet.

Aspects of embodiments provide a battery module, including rechargeable batteries, each of which includes the rechargeable battery as described above, and a cooling plate that contacts the rechargeable batteries, each of the rechargeable batteries contacting the cooling plate via one of the four surfaces constituting the side portion, and each of the rechargeable batteries contacting the side portion of an adjacent one of the rechargeable batteries via at least two surfaces of remaining three surfaces among the four surfaces.

### BRIEF DESCRIPTION OF THE DRAWINGS

Features will become apparent to those of skill in the art by describing in detail exemplary embodiments with reference to the attached drawings, in which:

FIG. 1 is a perspective view of a rechargeable battery according to embodiments.

FIG. 2 is an exploded perspective view of the rechargeable battery in FIG. 1.

FIG. 3 is a cross-sectional view of the rechargeable battery along line A-A of FIG. 1.

FIG. 4 is a cross-sectional view of the rechargeable battery along line B-B of FIG. 1.

FIG. 5 is a partial enlarged view of FIG. 4.

FIG. 6 is a plan view of a first current collecting plate of the rechargeable battery in FIG. 2.

FIG. 7 is a schematic diagram showing a portion of a battery module according to embodiments.

FIG. 8 is a partial cross-sectional view of a rechargeable battery according to other embodiments.

FIG. 9 is an exploded perspective view of a can and a cap plate in FIG. 8.

FIG. 10 is a partial perspective view of an electrode assembly of a rechargeable battery according to other embodiments.

FIG. 11 is a plan view of the electrode assembly in FIG. 10.

FIG. 12 is a partial perspective view of an electrode assembly of a rechargeable battery according to embodiments.

FIG. 13 is a plan view of the electrode assembly in FIG. 12.

FIG. 14 is a partial perspective view of an electrode assembly of a rechargeable battery according to embodiments.

FIG. 15 is a plan view of the electrode assembly in FIG. 14.

FIG. 16 is a perspective view of an electrode assembly of a rechargeable battery according to embodiments.

FIG. 17 is an enlarged cross-sectional view of a sheet laminate (or a sheet stack) of the electrode assembly in FIG. 16.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

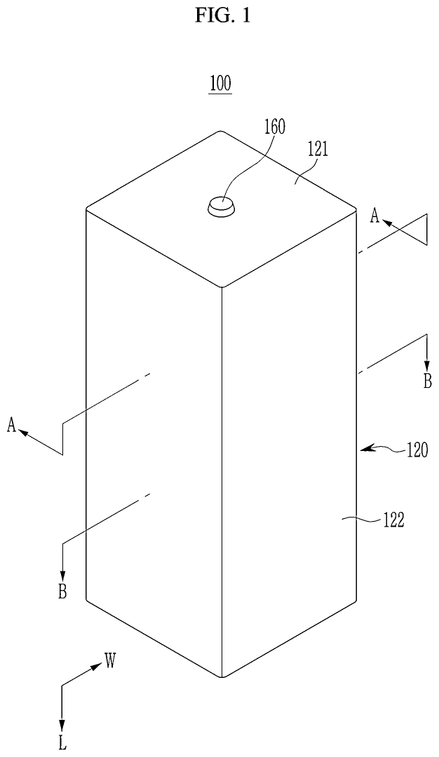

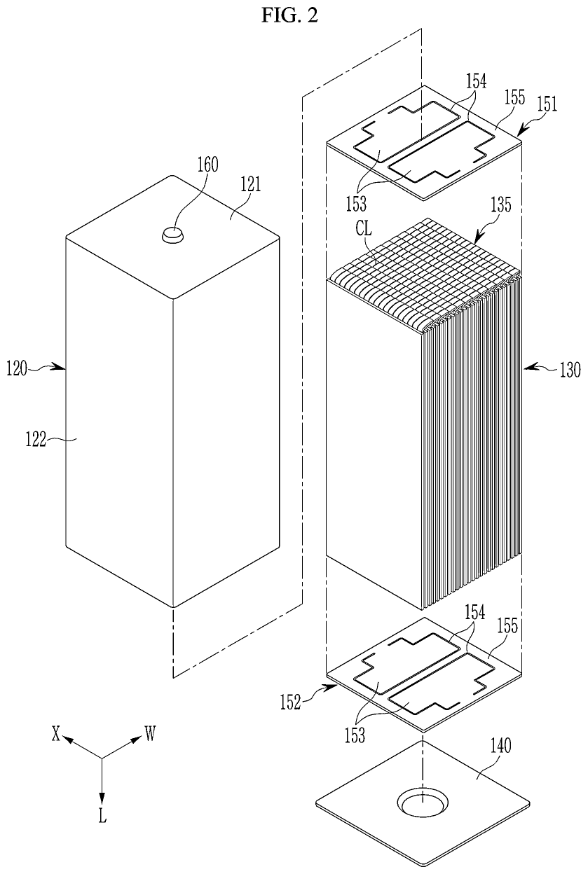

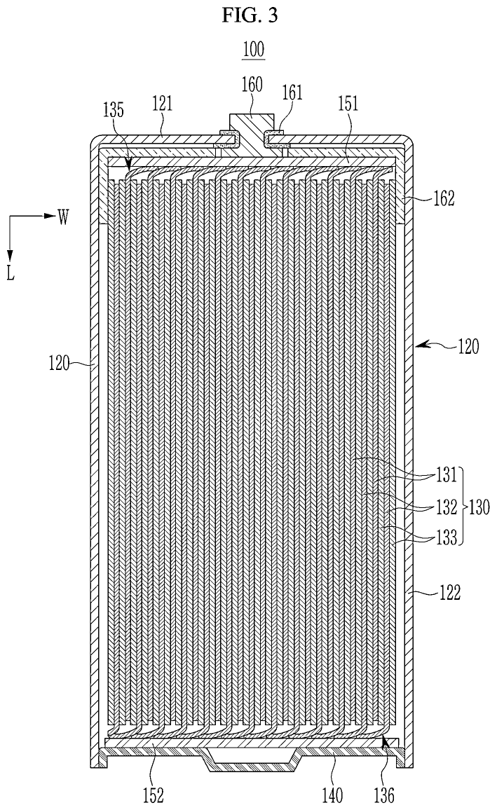

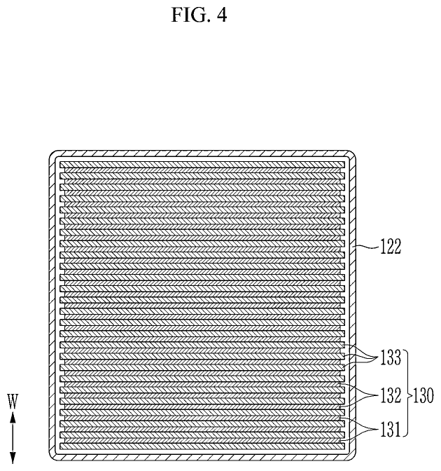

FIG. 1 is a perspective view of a rechargeable battery according to example embodiments, and FIG. 2 is an exploded perspective view of the rechargeable battery shown in FIG. 1. FIG. 3 is a cross-sectional view of the rechargeable battery along line A-A of FIG. 1, and FIG. 4 is a cross-sectional view of the rechargeable battery along line B-B of FIG. 1.

Referring to FIGS. 1 to 4, a rechargeable battery 100 according to the present embodiment may include a can 120, an electrode assembly 130 accommodated inside the can 120, and a cap plate 140 coupled to an end portion of the can 120 to seal the can 120. The electrode assembly 130 may include a plurality of sheet-type electrodes 131 and 132 stacked on each other, and current collecting plates 151 and 152 may be disposed at opposite sides (e.g., upper and lower sides) of the electrode assembly 130.

The can 120 may include a top portion 121 and a side portion 122 that is connected to an edge of the top portion 121 and has four surfaces (e.g., the side portion 122 may have four surfaces that surround the top portion 121). The top portion 121 may be referred to as a bottom portion if top and bottom of the can 120 are changed.

The top portion 121 may have a quadrangular (e.g., square) shape, the side portion 122 may have a hollow quadrangular (e.g., rectangular) tubular shape, and each of the four surfaces constituting the side portion 122 may have a rectangular shape. Each of the four surfaces constituting the side portion 122 may include two long sides perpendicular to the edge of the top portion 121 and two short sides parallel to the edge of the top portion 121. The can 120 may have a hollow square pillar shape.

An opening for installing a rivet terminal 160 may be disposed at a center of the top portion 121. In some embodiments, the rechargeable battery 100 may include a terminal having a different type from the rivet terminal 160, and the opening may be omitted at the top portion 121. The can 120 may be made of, e.g., steel, stainless steel, aluminum, an aluminum alloy, or the like.

Hereinafter, a direction parallel to a central axis (e.g., a longitudinal central axis) of the can 120 may be referred to as a length direction L of the rechargeable battery, and a direction in which two surfaces of the side portion 122 face each other among directions perpendicular to the length direction L may be referred to as a width direction W of the rechargeable battery. The four surfaces constituting the side portion 122 may include two pairs of faces facing each other, and a direction in which any one pair of the two pairs of faces facing each other may be referred to as the width direction W for convenience. In FIG. 3, the length direction L may coincide with a vertical direction of the drawings, and the width direction W may coincide with a horizontal direction of the drawings.

The electrode assembly 130 may include the plurality of sheet-type electrodes 131 and 132 stacked along the width direction W. The plurality of electrodes 131 and 132 may have a rectangular sheet shape, and may be disposed parallel to two surfaces facing each other along the width direction W among the four surfaces constituting the side portion 122. The plurality of electrodes 131 and 132 may have the same width and the same length.

The electrode assembly 130 may include the plurality of first electrodes 131 and the plurality of second electrodes 132 alternately disposed one by one along the width direction W, and a plurality of separators 133 disposed one by one between the first electrodes 131 and the second electrodes 132 adjacent to each other. Each separator 133 may have a rectangular sheet shape. The electrode assembly 130 may be accommodated inside the can 120 together with an electrolyte.

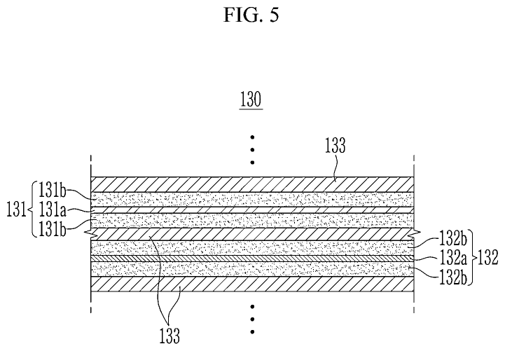

FIG. 5 is a partial enlarged view of FIG. 4. Referring to FIG. 5, the first electrode 131 may include a first substrate 131a and a first active material layer 131b disposed on the first substrate 131a. The second electrode 132 may include a second substrate 132a and a second active material layer 132b disposed on the second substrate 132a. The separator 133 may insulate the first electrode 131 and the second electrode 132 while allowing movement of a lithium ion.

The first substrate 131a may include, e.g., an aluminum (Al) foil, and the first active material layer 131b may include a transition metal oxide, e.g., LiCoO₂, LiNiO₂, LiMn₂O₄, or the like. The second substrate 132a may include, e.g., a copper (Cu) foil, a nickel (Ni) foil, or the like, and the second active material layer 132b may include a carbon-based material, e.g., graphite. The separator 133 may include a polymer material, e.g., polyethylene, polypropylene, or the like.

Referring back to FIGS. 1 to 4, an empty space may be present between a corner of the can 120 and an electrode assembly wound in a cylindrical shape inside the can 120, so that a capacity of the battery may be reduced. In contrast, in the rechargeable battery 100 of the present embodiment, the electrode assembly 130 may be arranged in a rectangular shape and disposed while minimizing the empty space inside the square pillar-type can 120, so that an output and a capacity of the battery may be increased.

The plurality of first electrodes 131 may include a plurality of first tabs 135 disposed at one side (e.g., an upper side) along the length direction L, and the plurality of second electrodes 132 may include a plurality of second tabs 136 disposed at the other side (e.g., a lower side) along the length direction L. The first tab 135 may be a portion of the first substrate 131a extended upwardly (e.g., extended above the electrode assembly 130), and the second tab 136 may be a portion of the second substrate 132a extended downwardly (e.g., extended below the electrode assembly 130). For example, as illustrated in FIGS. 2-3, each of the first tabs 135 may extend lengthwise in the L direction, and the first tabs 135 may be adjacent to each other in the width direction W. As illustrated in FIGS. 2-3, each of the first tabs 135 and the second tabs 136 may be bent in one direction to have an overlapping portion with an adjacent tab.

Referring to FIG. 2, a plurality of cutting lines CL may be disposed at each of the first tabs 135 and the second tabs 136, and each of the first tabs 135 and the second tabs 136 may be divided into a plurality of portions by the plurality of cutting lines CL. For example, as illustrated in FIG. 2, each of the plurality of cutting lines CL in each of the first tabs 135 may extend in the width direction W, and the plurality of the cutting lines CL in each of the first tabs 135 may be spaced apart from each other along the X direction. For example, as illustrated in FIG. 2, the cutting lines CL in one of the first tabs 135 may be aligned (e.g., colinear) with the cutting lines CL in the adjacent one of the first tabs 135.

For bending of the first tab 135, a jig may be in close contact with any one of outermost first tabs 135, and the jig may be moved along the width direction W to sequentially press and bend the plurality of first tabs 135. A bending process of the second tab 136 may also be performed in the same manner as that of the bending process of the first tab 135. The plurality of cutting lines CL may facilitate bending of the first tab 135 and the second tab 136 during the bending processes of the first tab 135 and the second tab 136.

Each of the plurality of first tabs 135 and the plurality of second tabs 136 may be overlapped and pressed by the bending to form a substantially flat surface. A structure in which the plurality of tabs 135 and 136 overlap adjacent tabs by the bending may increase a current collecting efficiency of the electrodes 131 and 132, and may improve welding reliability between the structure and the current collecting plates 151 and 152.

Each of the first current collecting plate 151 and the second current collecting plate 152 may be integrally fixed to each of the plurality of first tabs 135 and the plurality of second tabs 136 by, e.g., laser welding or the like. The first current collecting plate 151 and the second current collecting plate 152 may be formed of a square metal plate, and may include at least one plate spring portion 153 for improving welding reliability.

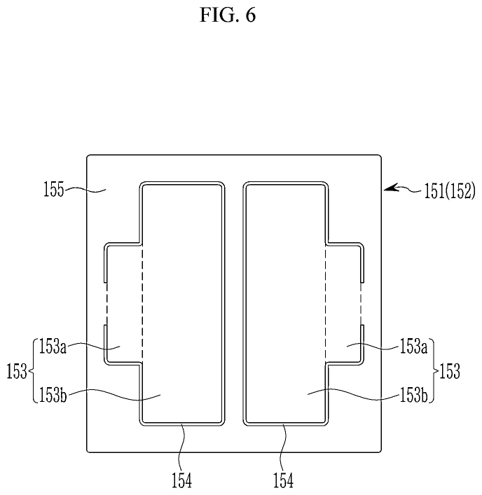

FIG. 6 is a plan view of the first current collecting plate 151 of the rechargeable battery shown in FIG. 2.

Referring to FIG. 6, the first current collecting plate 151 may be divided into an edge portion 155 and a pair of plate spring portions 153 by through lines 154 (e.g., two through lines 154). The plate spring portion 153 may be an inner portion of the through line 154 (e.g., the plate spring portion 153 may be an inner portion relative to and surrounded by the through lines 154), and the edge portion 155 may be an outer portion of the through line 154 (e.g., the edge portion 155 may be an outer portion relative to and surrounding the through lines 154). Both ends (e.g., opposite ends) of the through line 154 may be disposed at a distance from each other so that the plate spring portion 153 and the edge portion 155 are integrally connected. For example, the plate spring portion 153 and the edge portion 155 may be integrally connected to each other (e.g., formed of a same material as a single and seamless structure) through a space between the opposite ends of each of the through lines 154.

The plate spring portion 153 may be formed by combining a first portion 153a having a small rectangular shape and a second portion 153b having a large rectangular shape, and the first portion 153a may be connected to the edge portion 155 (e.g., through the space between the opposite ends of the through line 154). For example, the first portion 153a may be formed integrally with the second portion 153b. In the pair of plate spring portions 153, the second portions 153b may be disposed adjacent to each other, and the first portions 153a may be disposed opposite to each other (e.g., the first portions 153a may be separated from each other by the second portions 153b). The pair of plate spring portions 153 may be horizontally symmetrical or vertically symmetrical to each other.

The pair of plate spring portions 153 may move in a vertical direction with respect to the edge portion 155 (e.g., along the length direction L in FIG. 2), so that the pair of plate spring portions 153 may absorb vibration and impact that may occur during a welding process. Therefore, the first current collecting plate 151 may improve welding reliability with respect to the plurality of first tabs 135. The second current collecting plate 152 may have the same configuration as that of the first current collecting plate 151, and a repetitive description thereof is omitted.

Referring back to FIG. 2 and FIG. 3, the rivet terminal 160 may be installed at the opening of the top portion 121 in a state in which the rivet terminal 160 is surrounded by an insulating gasket 161, and may be coupled to the first current collecting plate 151 to be charged with the same polarity as that of the first electrode 131. For example, the rivet terminal 160 may function as a first terminal (e.g., a positive terminal). An insulating member 162 may be disposed inside the can 120 to overlap a portion of the top portion 121 and a portion of the side portion 122. The insulating member 162 may insulate the first current collecting plate 151 and the can 120 from each other.

The cap plate 140 may cover the second current collecting plate 152, and may be coupled to an end portion of the side portion 122 to seal the can 120. For example, as illustrated in FIG. 3, the cap plate 140 and the rivet terminal 160 may be at opposite sides of the can 120 along the length direction L. The cap plate 140 may be electrically connected to the second current collecting plate 152 to function as a second terminal (e.g., a negative terminal), and the cap plate 140 may be in contact with the can 120 so that the can 120 may also be charged with the same polarity as that of the second electrode 132.

In some embodiments, the second current collecting plate 152 may be in contact with the can 120, and the cap plate 140 may maintain an insulating state with the second current collecting plate 152 and the can 120 by an insulating gasket, and may be coupled to an end portion of the side portion 122. For example, the can 120 may function as a second terminal (e.g., a negative terminal), and the cap plate 140 may be electrically non-polar. For example, as illustrated in FIGS. 2-3, the second current collecting plate 152, the cap plate 140, and the can 120 may have a combined structure.

The cap plate 140 may be formed of a flat quadrangular (e.g., square) metal plate, or may include a portion that is convexly deformed toward an upper side or a lower side. Additionally, a notch groove may be disposed on at least one of the inner and outer surfaces of the cap plate 140. The notch groove may be formed as a V-shaped or U-shaped groove, and may be broken if an internal pressure of the rechargeable battery 100 increases so that an internal gas is discharged. Thus, explosion of the rechargeable battery 100 may be prevented.

In some embodiments, the plurality of first tabs 135 may be disposed at a lower side of the electrode assembly 130 to be electrically connected to the second current collecting plate 152 and the can 120, and the plurality of second tabs 136 may be disposed at an upper side of the electrode assembly 130 to be electrically connected to the first current collecting plate 151 and the rivet terminal 160. For example, the can 120 may be charged with the same polarity as that of the first electrode 131, and the rivet terminal 160 may be charged with the same polarity as that of the second electrode 132.

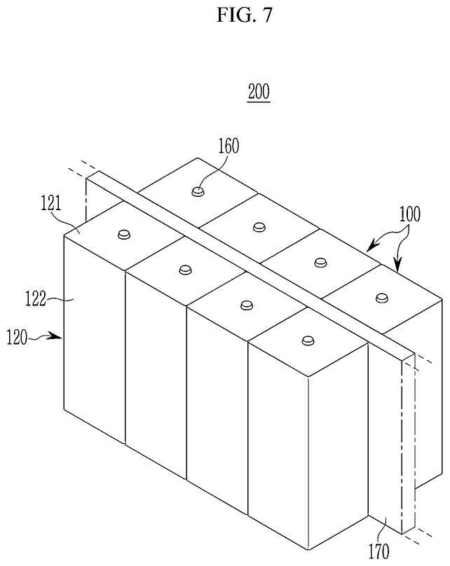

FIG. 7 is a schematic diagram showing a portion of a battery module according to embodiments.

Referring to FIG. 7, a battery module 200 may include a plurality of rechargeable batteries 100 in which side portions 122 of cans 120 are in contact (e.g., direct contact) with each other. The plurality of rechargeable batteries 100 may be in close contact with each other without an empty space, and may be disposed to form a plurality of rows and a plurality of columns so that the battery module 200 is formed.

The battery module 200 may include a cooling plate 170 disposed between the plurality of rechargeable batteries 100. The cooling plate 170 may absorb heat generated from the plurality of rechargeable batteries 100 to prevent overheating of the battery module 200. The cooling plate 170 may be disposed between the rechargeable batteries 100 of two adjacent rows, or between the rechargeable batteries 100 of two adjacent columns. The rechargeable battery 100 may be in contact with the cooling plate 170 on all of any one of the four surfaces constituting the side portion 122, and may be in contact with the side portions 122 of adjacent rechargeable batteries 100 on at least two of the remaining three surfaces among the four surfaces.

If a battery module were to include a plurality of cylindrical rechargeable batteries (rather than the rechargeable batteries 100 with the rectangular shape) aligned in rows on opposite sides of a cooling plate, a dead space (e.g., an empty space) would have occurred between adjacent ones of the cylindrical rechargeable batteries and between the cooling plate and the cylindrical rechargeable batteries (due to curved surfaces of the cylindrical cans). In addition, an area where the cylindrical rechargeable battery contacts the cooling plate would have been smaller than that of the embodiment shown in FIG. 7.

In contrast, referring to FIG. 7, the battery module 200 of the embodiments includes a plurality of rechargeable batteries 100 with a rectangular shape, thereby allowing side portions 122 of adjacent cans 120 of the rechargeable batteries 100 to contact each other along entire lengths thereof. As such, the dead space occurring between adjacent cylindrical rechargeable batteries may be filled (i.e., may be eliminated), so that an output and a capacity of the battery module 200 may be increased, e.g., compared with a battery module including a plurality of cylindrical rechargeable batteries. In addition, the battery module 200 of the embodiments may implement higher cooling performance, e.g., compared with a battery module including a plurality of cylindrical rechargeable batteries, by expanding a contact area between the can 120 and the cooling plate 170 (e.g., having a larger surface contact between two contacting flat surfaces).

Next, modified examples of the rechargeable battery will be described.

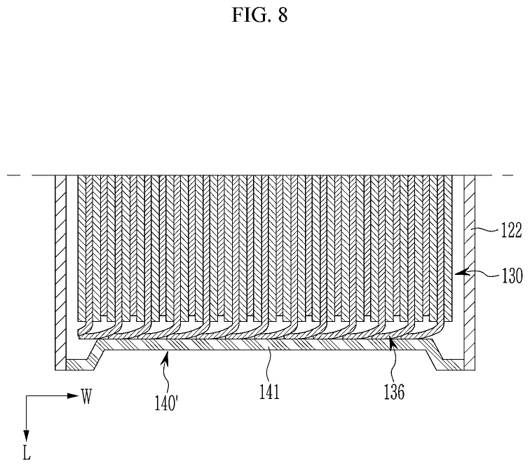

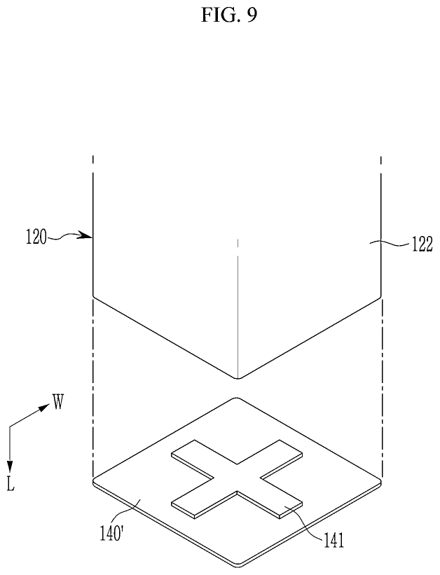

FIG. 8 is a partial cross-sectional view of a rechargeable battery according to an embodiment, and FIG. 9 is an exploded perspective view of a can and a cap plate shown in FIG. 8. The rechargeable battery in FIGS. 8-9 may have the same or similar configuration as that of the embodiment described with reference to FIGS. 1-6, above, except for a cap plate structure to be described below.

Referring to FIG. 8 and FIG. 9, a cap plate 140′ may be integrally fixed to the plurality of second tabs 136 by, e.g., laser welding or the like. For example, the second current collecting plate may be omitted, and the cap plate 140′ may function as the second current collecting plate.

The cap plate 140′ may include a welding portion 141 protruding toward the electrode assembly 130, and laser welding may be performed on the welding portion 141 so that the welding portion 141 is integrally fixed (e.g., directly attached) to the plurality of second tabs 136. For example, as illustrated in FIG. 9, the welding portion 141 may have a cross shape. In another example, the welding portion 141 may have any suitable shape.

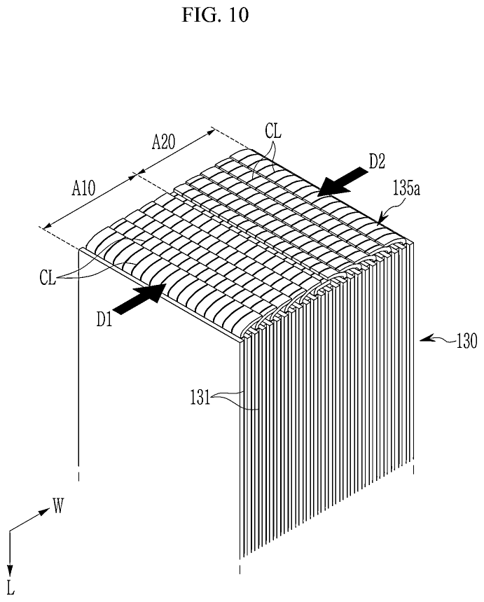

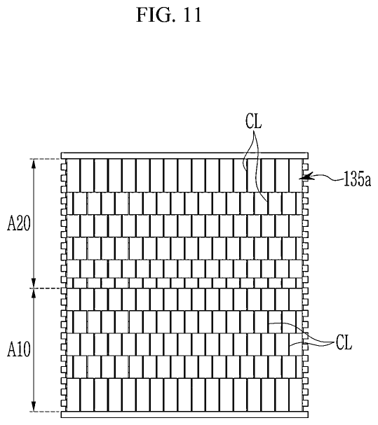

FIG. 10 is a partial perspective view of an electrode assembly of a rechargeable battery according to an embodiment, and FIG. 11 is a plan view of the electrode assembly shown in FIG. 10. The rechargeable battery in FIGS. 10-11 may have the same or similar configuration as that of the embodiment described with reference to FIGS. 1-6, above, except for a plurality of tabs described below.

Referring to FIG. 10 and FIG. 11, a plurality of first tabs 135a may have the same protruding length that is a length protruding upward from the first electrode 131, and each of the plurality of first tabs 135a may have a constant protruding length along a width direction of the first electrode 131. The width direction of the first electrode 131 may be orthogonal to both the length direction L and the width direction W of the rechargeable battery (e.g., the width direction of the first electrode 131 may extend along the X direction in FIG. 2). The plurality of cutting lines CL may be disposed at each first tab 135a, and the first tab 135a may be divided into a plurality of portions by the plurality of cutting lines CL.

As illustrated in FIG. 11, the plurality of cutting lines CL located on one first tab 135a may be disposed to be offset from (e.g., misaligned relative to or deviate) a plurality of cutting lines CL located on an adjacent first tab 135a along the width direction of the first electrode 131. For example, the plurality of cutting lines CL disposed at an odd-numbered first tab 135a among the plurality of first tabs 135a may be disposed to be offset along the width direction of the first electrode 131 from the plurality of cutting lines CL disposed at an even-numbered first tab 135a among the plurality of first tabs 135a.

As illustrated in FIG. 10, the plurality of first tabs 135a may include a first region A10 bent in a first direction D1 to have an overlapping portion with an adjacent first tab 135a, and a second region A20 bent in a second direction D2 different from the first direction D1 to have an overlapping portion with an adjacent first tab 135a. Both the first direction D1 and the second direction D2 may be parallel to the width direction W, and may be opposite to each other. For example, the second direction D2 may be a reverse direction to the first direction D1, or may be a negative first direction −D1.

A width of the first region A10 along a bending direction (the first direction D1) may be approximately half the width of the electrode assembly 130, and a width of the second region A20 along a bending direction (the second direction D2) may be approximately half the width of the electrode assembly 130. A thickness of the plurality of first tabs 135a after the bending may increase slightly at a boundary between the first region A10 and the second region A20, but the plurality of first tabs 135a may generally implement a uniform thickness by pressing with a jig.

As described above, the plurality of first tabs 135a may be divided into two regions A10 and A20, and the two regions A10 and A20 may be bent toward each other (e.g., a plurality of first tabs 135a in the first region A10 may be bent in the first direction D1, while a plurality of first tabs 135a in the second region A20 may be bent in the second direction to face the bent first tabs 135a in the first region A10). For example, the plurality of cutting lines CL disposed to be shifted from each other at two adjacent first tabs 135a may facilitate bending of the plurality of first tabs 135a if the plurality of first tabs 135a are bent.

Additionally, portions divided by the cutting line CL at the first tab 135a may be bent while opening slightly laterally during the bending process. The divided portions of the first tab 135a after the first tab 135a is bent may overlap above a slightly opened gap caused by the cutting line CL at an adjacent first tab 135a. Because the plurality of cutting lines CL disposed to be shifted from each other have an effect of dispersing the divided portions of the first tab 135a left and right without aligning the divided portions of the first tab 135a side by side along the width direction W, an overall thickness of the first tab 135a may be reduced after the bending.

The first tab 135a having the above-described configuration may increase a current collecting efficiency of the first electrodes 131, and may improve welding reliability between the first tab 135a and the first current collecting plate. The plurality of second tabs may have the same configuration as that of the plurality of first tabs 135a, and a repetitive description thereof is omitted.

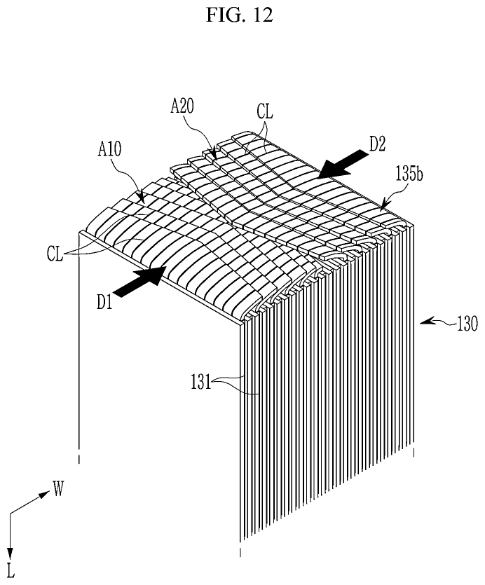

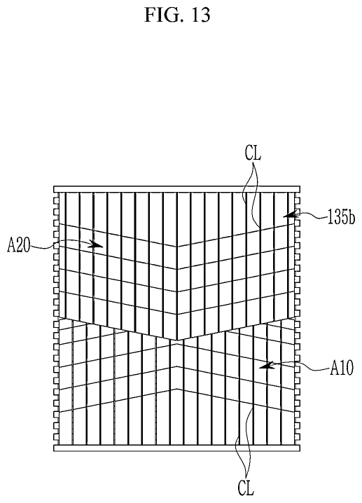

FIG. 12 is a partial perspective view of an electrode assembly of a rechargeable battery according to an embodiment, and FIG. 13 is a plan view of the electrode assembly shown in FIG. 12. The rechargeable battery in FIGS. 12-13 may have the same or similar configuration as that of the embodiments described with reference to FIGS. 1-11, above, except for a plurality of tabs described below.

Referring to FIG. 12 and FIG. 13, each of the plurality of first tabs 135b may have a shape in which a protruding length (e.g., in the W direction) of a central portion is greater than protruding lengths (e.g., in the W direction) of each of both end portions. For example, each of the plurality of first tabs 135b may have an upper portion of a triangle (e.g., each of the plurality of first tabs 135b may have a triangular edge having a vertex oriented in the W direction as viewed in a top view). The plurality of cutting lines CL may be disposed at each first tab 135b, and the first tab 135b may be divided into a plurality of portions by the plurality of cutting lines CL.

The plurality of first tabs 135b may include the first region A10 bent in the first direction D1 to have an overlapping portion with an adjacent first tab 135b, and the second region A20 bent in the reverse direction D2 to the first direction D1 to have an overlapping portion with an adjacent first tab 135b. At a boundary between the first region A10 and the second region A20, the central portion of the first tabs 135b belonging to the first region A10 may overlap the central portion of the first tabs 135b belonging to the second region A20.

The plurality of cutting lines CL disposed at the plurality of first tabs 135b may be disposed at the same position (e.g., aligned) along the width direction W. In some embodiments, the plurality of cutting lines CL located on one first tab 135b may be disposed to be offset from a plurality of cutting lines CL located on an adjacent first tab 135b along the width direction of the first electrode 131. In some embodiments, the plurality of cutting lines CL located on the plurality of first tabs 135b belonging to the first region A10 may be disposed to be offset from the plurality of cutting lines CL located on the plurality of first tabs 135b belonging to the second region A20 along the width direction of the first electrode 131, as illustrated in FIG. 13.

The plurality of cutting lines CL may facilitate bending of the plurality of first tabs 135b, and may reduce a thickness of the plurality of first tabs 135b after the bending. The plurality of second tabs may have the same configuration as that of the plurality of first tabs 135b, and a repetitive description thereof is omitted.

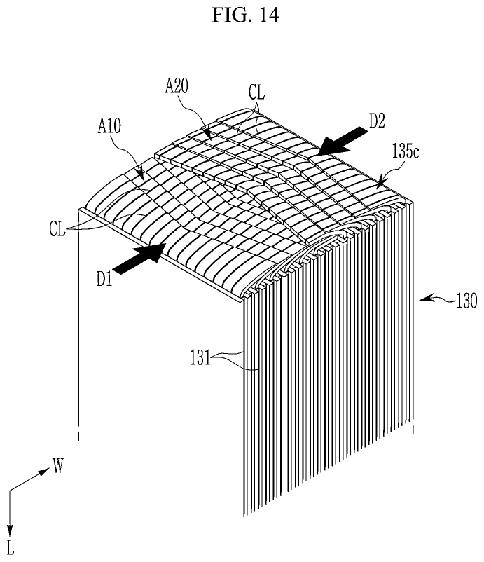

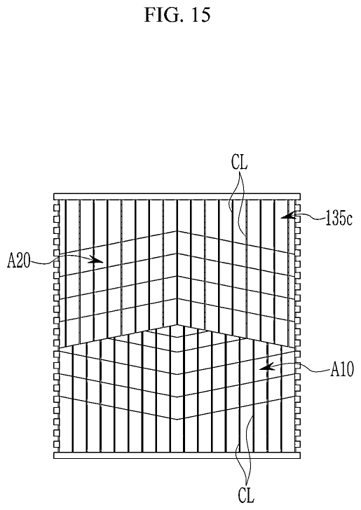

FIG. 14 is a partial perspective view of an electrode assembly of a rechargeable battery according to a fifth embodiment, and FIG. 15 is a plan view of the electrode assembly shown in FIG. 14. The rechargeable battery in FIGS. 14-15 may have the same or similar configuration as that of the embodiments described with reference to FIGS. 1-11, above, except for a plurality of tabs described below.

Referring to FIG. 14 and FIG. 15, each of the plurality of first tabs 135c may have a shape in which protruding lengths of both end portions is greater than a protruding length of a central portion. For example, each of the plurality of first tabs 135c may have a V-shaped upper portion. The plurality of cutting lines CL may be disposed at each first tab 135c, and the first tab 135c may be divided into a plurality of portions by the plurality of cutting lines CL.

The plurality of first tabs 135c may include the first region A10 bent in the first direction D1 to have an overlapping portion with an adjacent first tab 135c, and the second region A20 bent in the reverse direction D2 to the first direction D1 to have an overlapping portion with an adjacent first tab 135c. At a boundary between the first region A10 and the second region A20, left and right sides portions of the first tabs 135c belonging to the first region A10 may overlap left and right sides portions of the first tabs 135c belonging to the second region A20.

The plurality of cutting lines CL located on the plurality of first tabs 135c may be disposed at the same position along the width direction W. In some embodiments, the plurality of cutting lines CL located on one first tab 135c may be disposed to be offset from a plurality of cutting lines CL located on an adjacent first tab 135c along the width direction of the first electrode 131. In some embodiments, the plurality of cutting lines CL located on the plurality of first tabs 135c belonging to the first region A10 may be disposed to be offset from the plurality of cutting lines CL located on the plurality of first tabs 135c belonging to the second region A20 along the width direction of the first electrode 131, as illustrate in FIG. 15.

The plurality of cutting lines CL may facilitate bending of the plurality of first tabs 135c, and may reduce a thickness of the plurality of first tabs 135c after the bending. The plurality of second tabs may have the same configuration as that of the plurality of first tabs 135c, and a repetitive description thereof is omitted.

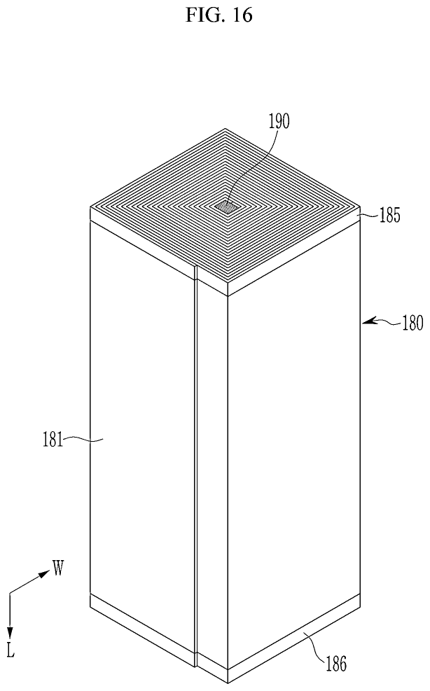

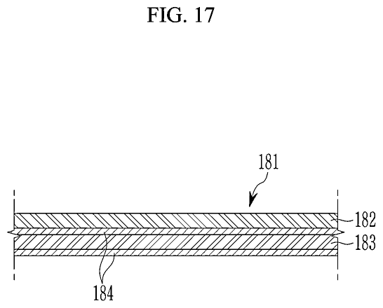

FIG. 16 is a perspective view of an electrode assembly of a rechargeable battery according to an embodiment, and FIG. 17 is an enlarged cross-sectional view of a sheet laminate (or a sheet stack) of the electrode assembly shown in FIG. 16. The rechargeable battery in FIGS. 16-17 may have the same or similar configuration as that of the embodiments described with reference to FIGS. 1-11, above, except for an electrode assembly described below.

Referring to FIG. 16, an electrode assembly 180 may have a structure in which a sheet laminate 181 is wound in a square rod shape. The sheet laminate 181 may include a first electrode sheet 182, a second electrode sheet 183, and a separator sheet 184 that have a band shape.

For example, the electrode assembly 180 may be manufactured by forming the sheet laminate 181 stacked in an order of the first electrode sheet 182, the separator sheet 184, the second electrode sheet 183, and the separator sheet 184, and winding the sheet laminate 181 in a square shape around a mandrel 190 having a square rod shape.

The first electrode sheet 182 may include a first tab 185 disposed at one side (e.g., an upper side) along the length direction L of the rechargeable battery, and the second electrode sheet 183 may include a second tab 186 disposed at the other side (e.g., a lower side) along the length direction L of the rechargeable battery. The first tab 185 may be a portion in which a portion of the first electrode sheet 182 extends toward the top portion, and the second tab 186 may be a portion in which a portion of the second electrode sheet 183 extends toward the cap plate.

The first tab 185 may be integrally fixed to the first current collecting plate, and the second tab 186 may be integrally fixed to the second current collecting plate. The electrode assembly 180 wound in the square shape may minimize an empty space, may be accommodated inside the can, and may increase an output and a capacity of the battery.

By way of summation and review, example embodiments provide a rechargeable battery that may increase an output and a capacity of a battery module by increasing integration of a plurality of rechargeable batteries when the battery module is formed by combining the plurality of rechargeable batteries, and a battery module including the same. That is, the battery module of the embodiments may densely dispose a plurality of rechargeable batteries without an empty space, and may realize high cooling performance by expanding a contact area between the rechargeable battery and the cooling plate.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
a can including a top portion and a side portion connected to an edge of the top portion, the top portion having a square shape, and the side portion having four surfaces;
an electrode assembly inside the can, the electrode assembly including electrodes stacked between two facing surfaces of the four surfaces of the side portion; and
a cap plate coupled to an end portion of the side portion, the cap plate being configured to seal the can.

2. The rechargeable battery of claim 1, wherein each of the electrodes has a rectangular sheet shape, the electrodes being positioned in parallel to the two facing surfaces.

3. The rechargeable battery of claim 1, wherein the electrode assembly includes tabs at each of a first side and a second side of the electrode assembly, the first side facing the top portion, and the second side facing the cap plate.

4. The rechargeable battery of claim 3, wherein each of the tabs includes cutting lines, each of the tabs being bent and having an overlapping portion with an adjacent one of the tabs.

5. The rechargeable battery of claim 4, wherein ones of the cutting lines in at least one of the tabs are offset relative to ones of the cutting lines in an adjacent one of the tabs.

6. The rechargeable battery of claim 4, wherein each of the tabs has a shape in which a protruding length of a central portion is greater than protruding lengths of both end portions.

7. The rechargeable battery of claim 4, wherein each of the tabs has a shape in which protruding lengths of both end portions are greater than a protruding length of a central portion.

8. The rechargeable battery of claim 4, wherein the tabs include a first region bent along a first direction and a second region bent along a reverse direction to the first direction.

9. The rechargeable battery of claim 8, wherein each of a width of the first region along the first direction and a width of the second region along the reverse direction to the first direction is half of a width of the electrode assembly.

10. The rechargeable battery of claim 8, wherein ones of the cutting lines at the first region deviate from ones of the cutting lines at the second region.

11. The rechargeable battery of claim 4, further comprising at least one current collecting plate fixed to the tabs, the at least one current collecting plate being divided into a pair of plate spring portions and an edge portion surrounding the pair of plate spring portions by two through lines.

12. The rechargeable battery of claim 11, wherein the tabs include:
first tabs at the first side of the electrode assembly and facing the top portion, the first tabs being fixed to the at least one current collecting plate; and
second tabs at the second side of the electrode assembly and facing the cap plate, the second tabs being fixed to the cap plate.

13. A rechargeable battery, comprising:
a can including a top portion and a side portion connected to an edge of the top portion, the top portion having a square shape, and the side portion having four surfaces;
an electrode assembly inside the can and including a sheet laminate in a square shape wound around a mandrel having a square rod shape, the sheet laminate including a first electrode sheet, a second electrode sheet, and at least one separator sheet, and the first electrode sheet including a first tab extending toward the top portion; and
a cap plate coupled to an end portion of the side portion, the cap plate being configured to seal the can, and the second electrode sheet of the electrode assembly including a second tab extending toward the cap plate.

14. The rechargeable battery of claim 13, wherein:
the at least one separator sheet includes a first separator sheet and a second separator sheet, and
the sheet laminate is stacked in an order of the first electrode sheet, the first separator sheet, the second electrode sheet, and the second separator sheet.

15. A battery module, comprising:
rechargeable batteries, each of which includes the rechargeable battery as claimed in claim 1; and
a cooling plate that contacts the rechargeable batteries, each of the rechargeable batteries contacting the cooling plate via one of the four surfaces constituting the side portion, and each of the rechargeable batteries contacting the side portion of an adjacent one of the rechargeable batteries via at least two surfaces of remaining three surfaces among the four surfaces.
